(19) United States
(12) Patent Application Publication
(10) Pub. No.: US 2026/0266590 A1
(43) Pub. Date: Sep. 10, 2026

(54) APPARATUS AND METHOD FOR MEASURING ANGLE OF INNER SURFACE OF OPTICAL COMPONENT IN HIGH-SPEED OPTICAL TRANSCEIVER MODULE

(71) Applicant: ACCELIGHT TECHNOLOGIES (WUHAN) CO,. LTD., Wuhan (CN)

(72) Inventors: Gong-En GU, Wuhan (CN); Michael Xiaoyan WEI, Wuhan (CN); William STERLING, Wuhan (CN); Meirong ZHANG, Wuhan (CN)

(73) Assignee: ACCELIGHT TECHNOLOGIES (WUHAN) INC., Wuhan (CN)

(21) Appl. No.: 19/552,986

(22) Filed: Feb. 27, 2026

(30) Foreign Application Priority Data
Mar. 10, 2025 (CN) 202510273666.2

(51) Int. Cl. G01B 9/10; G01B 11/26; G01M 11/00; G01M 11/02

(52) U.S. Cl. CPC G01B 9/10; G01B 11/26; G01M 11/0214; G01M 11/0264; G01M 11/33

(57) ABSTRACT

An apparatus for measuring an angle of an inner surface of an optical component in a high-speed optical transceiver module includes a vibration isolation table. A base of a light-receiving positioning plate, a mounting base and a visual recognition unit are disposed on the vibration isolation table. A light-receiving positioning plate is formed with an avoidance hole. After being focused by a telecentric objective and passing through an avoidance hole, a light beam emitted by a laser output head is projected onto a metal part. After passing through a central hole of the metal part and being reflected by a surface inside the metal part, the light beam is received by the light-receiving positioning plate. The present disclosure can be used to calculate the angle of the inner surface of the optical component.

### CROSS-REFERENCE TO RELATED APPLICATIONS

This application claims priority to Chinese Patent Application No. 202510273666.2, filed on Mar. 10, 2025, which is hereby incorporated by reference in its entirety.

### TECHNICAL FIELD

The present disclosure relates to the field of optical transceiver module technologies, and in particular, to an apparatus and a method for measuring an angle of an inner surface of an optical component in a high-speed optical transceiver module.

### BACKGROUND

With the vigorous development of artificial intelligence technology, the application of artificial intelligence technology has led to explosive growth in the demand for computing power. In this context, the construction scale of data centers and supercomputing centers is continuously expanding, which directly drives the continuous expansion of the high-speed optical transceiver module market. In recent years, the global demand for high-speed optical transceiver modules has increased sharply. Correspondingly, the demand for various optical component, as core components of high-speed optical transceiver modules, has also become increasingly strong.

In optical component, due to the structural characteristic of the receiver, the ferrule of the receiver is encapsulated inside the metal part. This special structural design presents a detection challenge: if traditional detection methods such as using microscopes are adopted, it is impossible to effectively observe and measure the end face angle and the orientation of the high side of the ferrule. Especially in some application scenarios, the receiver needs to be docked with a free space isolator (FSI), which requires accurate knowledge of the angle and high/low side orientation information of the inner surface to ensure the correctness of the docking direction. However, there is no mature detection apparatus in the industry that can reliably measure the angle parameter, and a high-side position and a low-side position of the ferrule inside the metal part of the receiver.

Therefore, it is urgent to develop an apparatus for measuring an angle of an inner surface of an optical component in a high-speed optical transceiver module to solve the above technical problem.

### SUMMARY

In view of the technical problem existing in the conventional technologies, the present disclosure provides an apparatus and a method for measuring an angle of an inner surface of an optical component in a high-speed optical transceiver module. The apparatus and the method can calculate the angle of the inner surface of the optical component and determine a high-side position and a low-side position of the inner surface at the same time through visual recognition of a position and an angle of a reflected light by means of a charge-coupled device (CCD).

The technical solution provided by the present disclosure to solve the technical problem is as follows.

The present disclosure discloses an apparatus for measuring an angle of an inner surface of an optical component in a high-speed optical transceiver module, and the apparatus includes a vibration isolation table, a base of a light-receiving positioning plate, a mounting base, a visual recognition unit, a light-receiving positioning plate, a laser output head, a telecentric objective, a multi-axis adjusting coupling frame, a multi-axis adjusting unit and a metal part fixing fixture;

wherein the base of the light-receiving positioning plate, the mounting base and the visual recognition unit are disposed on the vibration isolation table, the light-receiving positioning plate is disposed between the base of the light-receiving positioning plate and the mounting base, and the light-receiving positioning plate is located within an imaging range of the visual recognition unit; the laser output head, the telecentric objective and the multi-axis adjusting coupling frame are disposed on the base of the light-receiving positioning plate, the multi-axis adjusting coupling frame is configured to adjust a relative position between the laser output head and the telecentric objective, the multi-axis adjusting unit and the metal part fixing fixture connected to a moving end of the multi-axis adjusting unit are disposed on the mounting base; and the light-receiving positioning plate is formed with an avoidance hole, after being focused by the telecentric objective and passing through the avoidance hole, a light beam emitted by the laser output head is projected onto a metal part located in the metal part fixing fixture, and after passing through a central hole of the metal part and being reflected by a surface of a ceramic component or a glass component inside the metal part, the light beam is received by the light-receiving positioning plate; and the multi-axis adjusting unit includes a plate, an motorized rotary stage and a multi-dimensional adjusting frame; the plate is configured to be axially displaceable along the metal part, the motorized rotary stage, being rotatable around a central axis of the metal part, is disposed on the plate, the multi-dimensional adjusting frame is connected to the motorized rotary stage, and the metal part fixing fixture is connected to a moving end of the multi-dimensional adjusting frame; the plate is configured to adjust a far-near field of the multi-dimensional adjusting frame to move ΔL, so as to calculate the angle of the inner surface of the optical component.

Beneficial effects produced by the present disclosure may as follows. The present disclosure realizes accurate measurement of an angle and position a high-side position and a low-side position of a ferrule inside the metal part in the high-speed optical transceiver module by providing the apparatus for measuring the angle of the inner surface of the optical component based on CCD visual recognition. The apparatus overcomes a technical problem that a traditional detection method such as using microscopes can not effectively observe the ferrule inside the metal part, and provides a reliable detection solution for assembly and quality control of the high-speed optical transceiver module.

According to the present disclosure, a complete optical path measurement system can be established by providing a light-receiving positioning plate, a multi-axis adjusting unit and a CCD detection system on a vibration isolation table. A light beam focused by a telecentric objective is reflected by an inner surface of a metal part and then received by the light-receiving positioning plate. By further combining a CCD visual recognition technology, position information of a reflected light spot can be accurately acquired. The solution can not only accurately calculate an angle parameter of the inner surface of the means, but also determine a high-side position and a low-side position through an orientation of the reflected light spot on the light-receiving positioning plate, so as to provide accurate direction guidance for subsequent docking with a FSI.

In addition, the present disclosure adopts a combined design of a multi-axis adjusting coupling frame and a multi-dimensional adjusting frame, so that accurate adjustment of an optical path and flexible control of a position of the means is ensured during a measurement process.

The present disclosure not only solves the technical problem that an angle parameter of a ferrule inside a metal part can not be effectively measured in the conventional technologies, but also provides an accurate, efficient and reliable measurement solution through systematic design. The present disclosure has important practical significance for promoting development of the high-speed optical transceiver module industry.

### BRIEF DESCRIPTION OF THE DRAWINGS

The present disclosure is further described below in conjunction with the accompanying drawings and embodiments.

FIG. 1 is a schematic diagram of an apparatus for measuring an angle of an inner surface of an optical component in a high-speed optical transceiver module according to an embodiment of the present disclosure.

FIG. 2 is a schematic diagram of a multi-axis adjusting coupling frame of an apparatus for measuring an angle of an inner surface of an optical component in a high-speed optical transceiver module according to an embodiment of the present disclosure.

FIG. 3 is an enlarged schematic diagram of a multi-axis adjusting coupling frame of an apparatus for measuring an angle of an inner surface of an optical component in a high-speed optical transceiver module according to an embodiment of the present disclosure.

FIG. 4 is a schematic diagram of a multi-axis adjusting unit of an apparatus for measuring an angle of an inner surface of an optical component in a high-speed optical transceiver module according to an embodiment of the present disclosure.

FIG. 5 is a schematic diagram of a light-receiving positioning plate of an apparatus for measuring an angle of an inner surface of an optical component in a high-speed optical transceiver module according to an embodiment of the present disclosure.

FIG. 6 is a schematic diagram of a metal part fixing fixture of an apparatus for measuring an angle of an inner surface of an optical component in a high-speed optical transceiver module according to an embodiment of the present disclosure.

FIG. 7 is a schematic diagram of an optical path for a metal part in an apparatus for measuring an angle of an inner surface of an optical component in a high-speed optical transceiver module according to an embodiment of the present disclosure.

FIG. 8 is a schematic diagram of a light-receiving positioning plate receiving a reflected light spot of an apparatus for measuring an angle of an inner surface of an optical component in a high-speed optical transceiver module according to an embodiment of the present disclosure.

FIG. 9 is a schematic diagram of a metal part in the conventional technologies.

### DETAILED DESCRIPTIONS OF THE EMBODIMENTS

In order to make objectives, technical solutions and advantages of the present disclosure clearer, the present disclosure is further described in detail below in conjunction with accompanying drawings and embodiments. It should be understood that the specific embodiments described herein are only used to explain the present disclosure and are not used to limit the present disclosure.

The specific implementation of the present disclosure is described in detail below to provide a comprehensive understanding of an apparatus and a method for measuring an angle of an inner surface of an optical component in a high-speed optical transceiver module.

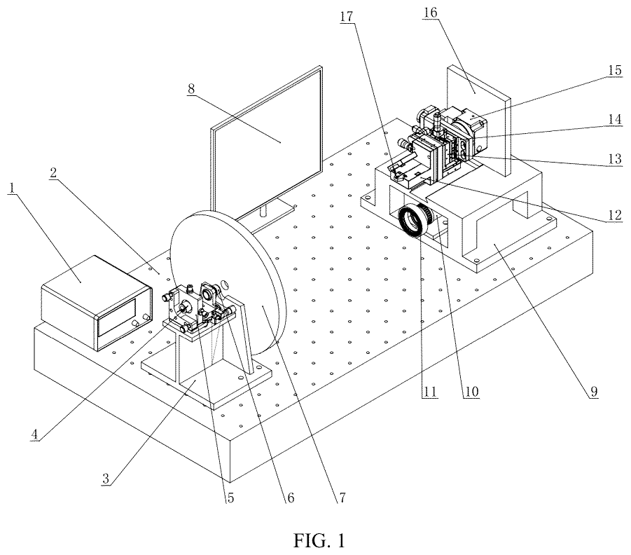

As shown in FIG. 1, an embodiment of the present disclosure provides an apparatus for measuring an angle of an inner surface of an optical component in a high-speed optical transceiver module. An overall structure of the apparatus is disposed on a vibration isolation table 2 to ensure that a measurement process can not be affected by external vibration. A base 3 of a light-receiving positioning plate, a mounting base 9 and a visual recognition unit are disposed on the vibration isolation table 2. The base 3 of the light-receiving positioning plate and the mounting base 9 are arranged at intervals along an X-axis direction. The visual recognition unit is located between the base 3 of the light-receiving positioning plate and the mounting base 9. The base 3 of the light-receiving positioning plate and the mounting base 9 jointly constitute a basic support structure of the apparatus. A light-receiving positioning plate 7 is disposed between the base 3 of the light-receiving positioning plate and the mounting base 9. The light-receiving positioning plate 7 is accurately positioned within an imaging range of the visual recognition unit to ensure accuracy of image acquisition.

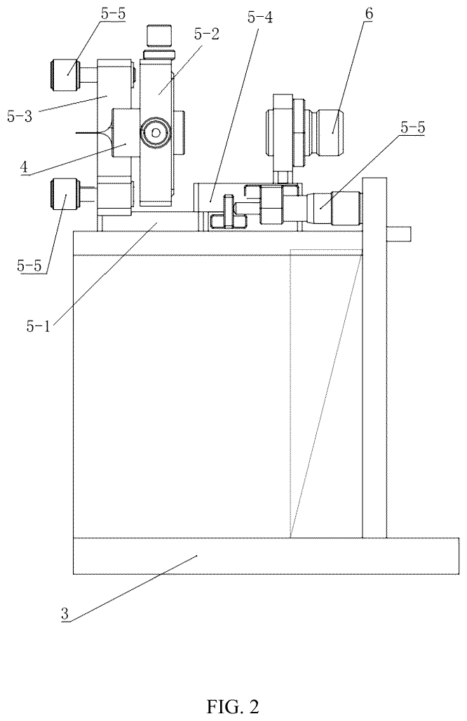

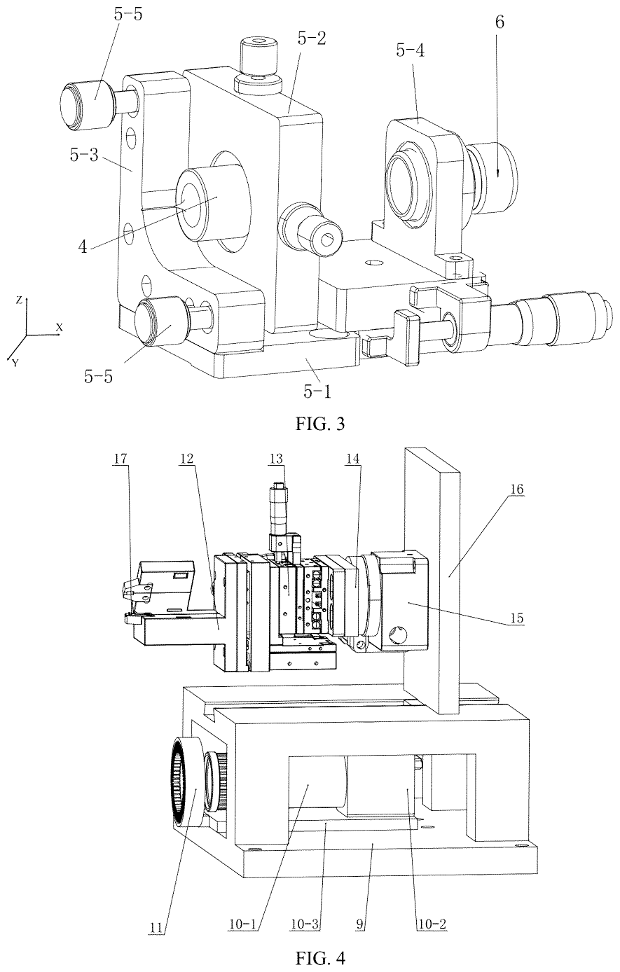

As shown in FIG. 2 and FIG. 3, according to the embodiment of the present disclosure, the base 3 of the light-receiving positioning plate is provided with a laser optical path system. The laser optical path system includes a visible laser source 1, a laser output head 4 and a telecentric objective 6. The visible laser source 1 is connected to the laser output head 4. The visible laser source 1 and the laser output head 4 can cooperate to output visible light with a small diameter and high collimation. Since laser light is mostly collimated light, the telecentric objective 6 is provided for focusing the light to make a size of a light spot less, so that the laser light can accurately hit an inner surface of a metal part. To achieve precise adjustment of the relative position between the laser output head 4 and the telecentric objective 6, a multi-axis adjusting coupling frame 5 is provided. The multi-axis adjusting coupling frame 5 includes a bottom plate 5-1, a first plate 5-2, a vertical plate 5-3, a second plate 5-4 and spiral jacking rods 5-5. The bottom plate 5-1 is fixed on the base 3 of the light-receiving positioning plate. The vertical plate 5-3 is fixedly disposed on the bottom plate 5-1. The first plate 5-2 connected to the vertical plate 5-3 and the second plate 5-4 displaceable along the X-axis direction are disposed on the bottom plate 5-1. The vertical plate 5-3 is L-shaped. The laser output head 4 is displaceable along a Z-axis direction and a Y-axis direction and is disposed on the first plate 5-2. The spiral jacking rods 5-5 for enabling the first plate 5-2 to rotate around a Z-axis are disposed on the vertical plate 5-3. The spiral jacking rods 5-5 are disposed at both ends of the vertical plate 5-3. The telecentric objective 6 is disposed on the second plate 5-4.

As shown in FIG. 4, a mechanism system for fixing and adjusting a position of a metal part to be measured 17 is disposed on the mounting base 9. The mechanism system includes a multi-axis adjusting unit. A core component of the multi-axis adjusting unit is a plate 16 axially displaceable along the metal part to be measured 17. An motorized rotary stage 15 is disposed on the plate 16. The motorized rotary stage 15 is configured to make the metal part to be measured 17 rotate around a central axis of the metal part to be measured 17. The motorized rotary stage 15 is connected to a multi-dimensional adjusting frame 13, and the multi-dimensional adjusting frame 13 is connected to the metal part fixing fixture 12. A design of the multi-dimensional adjusting frame 13 can be comprehensive. The multi-dimensional adjusting frame 13 may include an X-axis linear stage module, a Y-axis linear stage module, a Z-axis linear stage module, as well as an X-axis rotation module, a Y-axis rotation module and a Z-axis rotation module. Cooperation of these modules can realize the precise adjustment of the metal part to be measured 17 in all spatial directions.

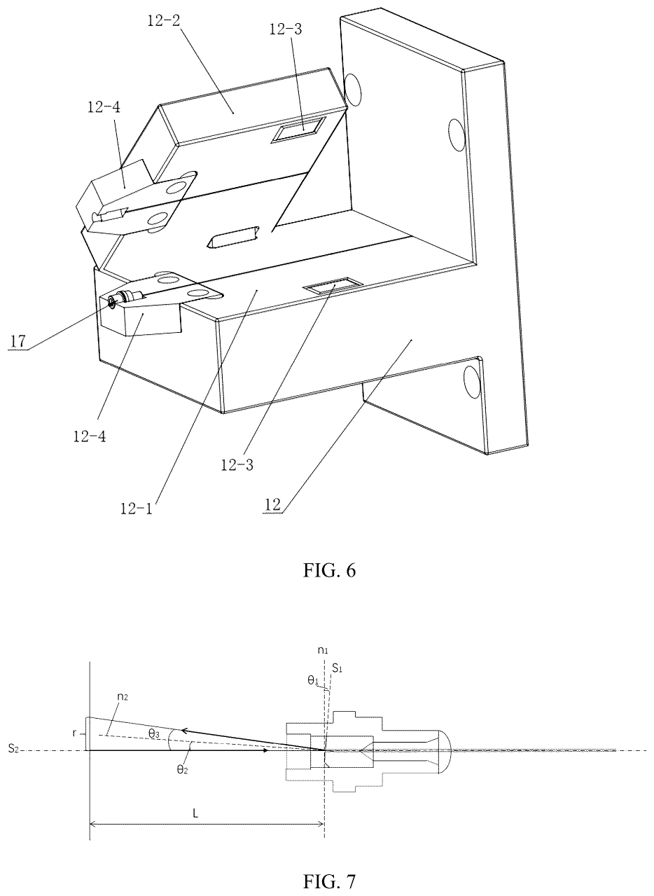

As shown in FIG. 6, the metal part fixing fixture 12 includes a base plate 12-1 and a cover plate 12-2. The base plate 12-1 and the cover plate 12-2 each include an optical fiber semicircular limiting groove and a metal part limiting groove. The optical fiber semicircular limiting groove of the base plate 12-1 and the optical fiber semicircular limiting groove of the cover plate 12-2 are correspondingly arranged, and the metal part limiting groove of the base plate 12-1 and the metal part limiting groove of the cover plate 12-2 are correspondingly arranged, so as to accurately position the metal part to be measured 17. To improve convenience and reliability of clamping, the base plate 12-1 and the cover plate 12-2 each include a magnet 12-3, and the magnet 12-3 on the base plate 12-1 and the magnet 12-3 on the cover plate 12-2 are disposed at corresponding positions, so as to realize quick fixation through magnetic force. At the same time, the base plate 12-1 and the cover plate 12-2 are each detachably connected to a positioning block 12-4 respectively. The metal part limiting groove is disposed on the positioning block 12-4. The design greatly improves versatility and maintenance convenience of the apparatus. A detachable design and a magnet positioning structure of the metal part fixing fixture 12 may improve convenience and repeatability of a measurement operation. These innovative designs not only improve measurement accuracy, but also significantly improve the measurement efficiency, meeting the urgent demand of the current high-speed optical transceiver module market for optical component detection.

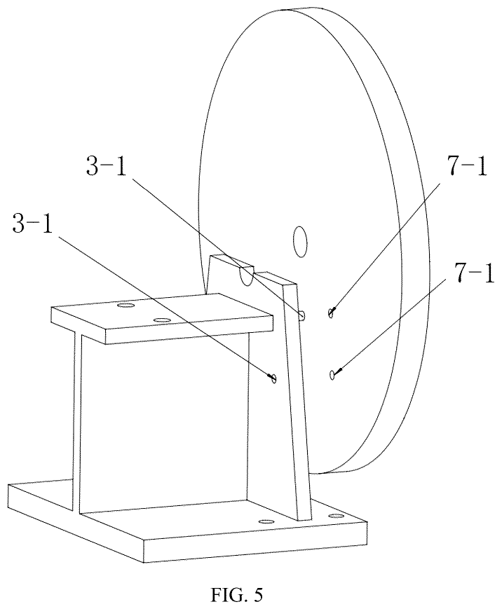

As shown in FIG. 5, according to the embodiment of the present disclosure, the base 3 of the light-receiving positioning plate includes a plurality of positioning pin shafts 3-1. The plurality of positioning pin shafts 3-1 are mated with positioning holes 3-2 provided on the light-receiving positioning plate 7. The positioning method ensures accuracy and repeatability of an installation position of the light-receiving positioning plate 7. The light-receiving positioning plate 7 is formed with an avoidance hole, so that a light beam emitted from the laser output head 4 and focused by the telecentric objective 6 can pass through the avoidance hole, and then reach the metal part to be measured 17 fixed in the metal part fixing fixture 12. The light beam passes through a central hole of the metal part to be measured 17, is reflected by a surface of a ceramic component or a glass component inside the metal part to be measured 17, and then is received by the light-receiving positioning plate 7. An angle, a high-side position and a low-side position of a surface inside the metal part to be measured 17 can be determined by a position of the reflected light. By adjusting the relative position between the laser output head 4 and the telecentric objective 6 through the adjusting coupling frame, a size of the output light spot is less within a service distance range.

As shown in FIG. 1, an image acquisition system of the apparatus includes the visual recognition unit. The visual recognition unit includes a CCD 10 and a display 8. The CCD 10 and the display 8 are connected through a data cable. In order to provide a good lighting condition, an annular light source 11 is disposed on a lens of the CCD 10. The design can ensure sufficient and uniform lighting during image acquisition. The CCD 10 can be disposed on the mounting base 9.

In an actual measurement process, a metal part to be measured 17 (a structure of the metal part to be measured 17 is shown in FIG. 9) is fixed in a metal part fixing fixture 12. Through precise adjustment by a multi-axis adjusting unit, a reflected light spot can be accurately focused on a light-receiving positioning plate 7. A CCD 10 collects an image of the light spot on a light-receiving positioning plate 7 and transmits data to a display 8 for real-time display and analysis. By measuring a variation of a position of the light spot and combining with a pre-calibrated parameter, an angle parameter of a surface inside the metal part to be measured 17 can be calculated.

This embodiment fully demonstrates innovative breakthrough of the present disclosure in precision optical alignment and fixation technology, and provides a key technical solution for measuring an angle of an inner surface of an optical component in a high-speed optical transceiver module.

An embodiment of the present disclosure further provides a method for measuring an angle of an inner surface of an optical component in a high-speed optical transceiver module using the apparatus. Specific implementation steps of the method are described in detail below.

The first step is the system calibration stage. A primary task of the stage is to establish an accurate measurement reference. During specific operation, a 0° plane standard means is first placed in the metal part fixing fixture 12. The standard means has an important impact on measurement accuracy of subsequent measurements. Therefore, a standard means having been calibrated and meeting a flatness requirement shall be selected. After the standard means is placed, each degree of freedom of the multi-axis adjusting unit (the multi-axis adjusting unit includes the displaceable plate 16, the motorized rotary stage 15 and the multi-dimensional adjusting frame 13) is adjusted, so as to make a light beam reflected from a surface of the standard means accurately return to a center of the light-receiving positioning plate 7. A purpose of this step is to establish the reference position of an entire optical path system.

Then perpendicularity calibration is performed. An operator moves the 0° plane standard means outward by a preset distance ΔL through the multi-axis adjusting unit (through cooperation of the displaceable plate 16 and the multi-dimensional adjusting frame 13). When the preset distance is selected, an overall size and an accuracy requirement of the measurement system shall be considered. Usually, a moderate distance value is recommended. The distance value shall be neither too small, resulting in insufficient adjustment sensitivity, nor too large, resulting in exceeding a measurement range of the system. After the movement is completed, the multi-axis adjusting unit is adjusted again, so that the reflected light returns along an original path. A purpose of this step is to ensure that a far-near field movement axis of the multi-axis adjusting unit is strictly perpendicular to a plane of the light-receiving positioning plate 7. In some embodiments, the plate of the multi-axis adjusting unit is configured to adjust the far-near field of the multi-dimensional adjusting frame to move ΔL, so as to calculate the angle of the inner surface of the optical component.

Next, rotation axis calibration is performed. The 0° plane standard means is rotated 360° around a central axis of the 0° plane standard means through the motorized rotary stage 15, and a position variation of a reflected light spot is observed at the same time. By finely adjusting various parameters of the multi-axis adjusting unit, the reflected light spot is kept at the center of the light-receiving positioning plate 7 during the entire rotation process. A core purpose of this step is to ensure that a rotation axis is perpendicular to the plane of the light-receiving positioning plate 7, laying foundation for subsequent angle measurement.

After the system calibration is completed, proceed to an actual measurement stage. An optical component to be measured is first placed in the calibrated metal part fixing fixture 12. Attention should be paid to keeping the metal part fixing fixture 12 stable during placement to avoid position deviation. The means to be measured is fixed by the base plate 12-1 and the cover plate 12-2, and a stable magnetic clamping force is provided by the magnets 12-3. Then a distance L between an inner surface of the optical component to be measured and the light-receiving positioning plate 7 is set. Selection of this distance is critical. The distance needs to be large enough to ensure measurement sensitivity, so that a minute variation of a position of the reflected light spot can be accurately captured.

During the measurement process, the light beam emitted by the laser output head 4 is focused by the telecentric objective 6, passes through the avoidance hole of the light-receiving positioning plate 7, and then reaches the surface of the means to be measured. The CCD 10 collects position information of the reflected light spot on the light-receiving positioning plate 7. The annular light source 11 provides a uniform lighting condition. Through image processing technology, a distance r between the reflected light spot to the center of the light-receiving positioning plate 7 is accurately measured. For the distance measurement, a resolution of the CCD 10 and a shape characteristic of the light spot shall be further considered, so as to ensure the measurement accuracy. At the same time, the CCD 10 is further configured to acquire azimuth angle information of the reflected light spot on the light-receiving positioning plate 7.

Next step is a data processing stage. The system calculates, based on the preset distance L and the measured distance r, an actual angle of the inner surface of the optical component to be measured by using principles of geometric optics. By analyzing the azimuth angle of the reflected light spot on the light-receiving positioning plate 7, a high-side position and a low-side position of the inner surface of the optical component can be accurately determined. This information has important guiding significance for subsequent installation and debugging of the means.

Finally, the system displays the calculated angle value and the position information of the high side and the low side on the display 8 in real time. Displayed content should be clear and intuitive, easy for the operator to read and record. These data can be used for quality control and production records to ensure consistency and traceability of a product.

By performing the above steps, the measurement method of the present disclosure can realize the accurate measurement of the inner surface angle of the optical component in the high-speed optical transceiver module, and provide reliable technical support for product quality control. The method has standardized operation and clear steps, and has good practicability and repeatability.

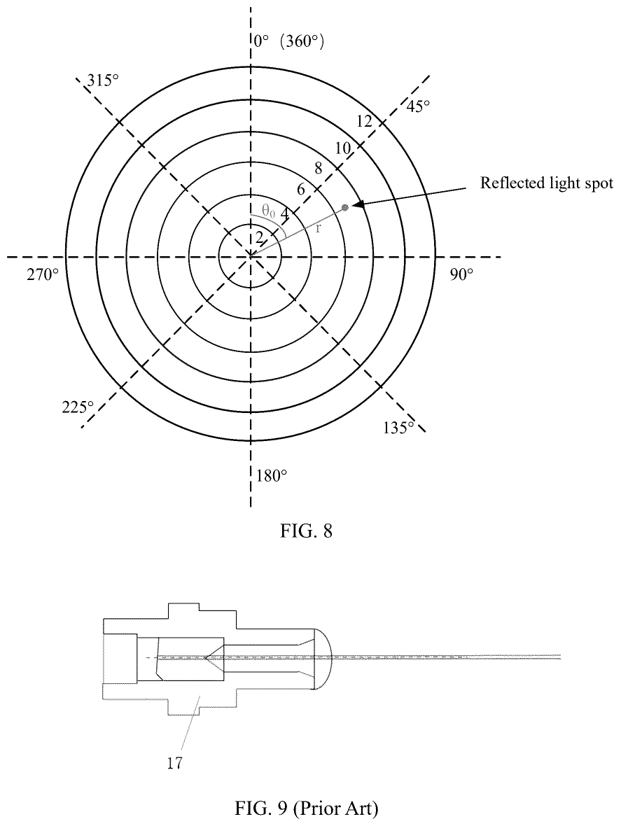

A test optical path of the present disclosure is shown in FIG. 7 and FIG. 8. A distance between the inner surface of the optical component and the light-receiving positioning plate is L. L shall be set to a relatively large distance to make a change of the distance r between the reflected light spot and the center of the light-receiving positioning plate more obvious, so that the measured angle is more accurate. n2 is a normal line of an inner surface S1 of the means. n2 is perpendicular to S1, and n1 is perpendicular to S2, so

$${θ}_{1} = {θ}_{2} = \frac{1}{2} {θ}_{3} .$$

Meanwhile,

$$tan {θ}_{3} = \frac{r}{L} .$$

Therefore,

$${θ}_{1} = \frac{1}{2} {tan}^{- 1} ( \frac{r}{L} ) .$$

L is known, and r is obtained by measuring the distance between the reflected light spot and the center of the light-receiving positioning plate, so that the angle θ₁ of the inner surface S1 of the means can be obtained.

Alternatively, the angle θ₁ can be calculated based on a Δr and a ΔL. The Δr is a variation of the distance between the reflected light spot and the center of the light-receiving positioning plate 7 when the far-near field of the multi-dimensional adjusting frame 13 is adjusted to move the the ΔL. Specifically, the angle θ₁ can be calculated according to a relation:

$${θ}_{1} = \frac{1}{2} {tan}^{- 1} ( \frac{Δ r}{Δ L} ) .$$

At the same time, as shown in FIG. 7 and FIG. 8, an orientation of the reflected light on the light-receiving positioning plate is consistent with an orientation of the low side. Therefore, positions of the high side and the low side of the inner surface of the optical component can be acquired and identified through an angle θ₀ of the light spot on the light-receiving positioning plate.

The above calculations can be automatically performed by the CCD after the CCD detects the light-receiving positioning plate and the position of the light spot reflected on the light-receiving positioning plate through visual recognition, and identified on the display.

It should be understood that those skilled in the art can make improvements or changes according to the above description, and all these improvements and changes should belong to the protection scope of the appended claims of the present disclosure.

What is claimed is:

1. An apparatus for measuring an angle of an inner surface of an optical component in a high-speed optical transceiver module, comprising a vibration isolation table, wherein a base of a light-receiving positioning plate, a mounting base, and a visual recognition unit are disposed on the vibration isolation table, a light-receiving positioning plate is disposed between the base of the light-receiving positioning plate and the mounting base, and the light-receiving positioning plate is located within an imaging range of the visual recognition unit; a laser output head, a telecentric objective and a multi-axis adjusting coupling frame configured to adjust a relative position between the laser output head and the telecentric objective are disposed on the base of the light-receiving positioning plate, a multi-axis adjusting unit and a metal part fixing fixture connected to a moving end of the multi-axis adjusting unit are disposed on the mounting base; and the light-receiving positioning plate is formed with an avoidance hole, after being focused by the telecentric objective and passing through the avoidance hole, a light beam emitted by the laser output head is projected onto a metal part located in the metal part fixing fixture, and after passing through a central hole of the metal part and being reflected by a surface of a ceramic component or a glass component inside the metal part, the light beam is received by the light-receiving positioning plate; and
the multi-axis adjusting unit comprises a plate axially displaceable along the metal part, a motorized rotary stage rotatable around a central axis of the metal part is disposed on the plate, a multi-dimensional adjusting frame is connected to the motorized rotary stage, and the metal part fixing fixture is connected to a moving end of the multi-dimensional adjusting frame; and the plate is configured to adjust a far-near field of the multi-dimensional adjusting frame to move ΔL, so as to calculate the angle of the inner surface of the optical component.

2. The apparatus for measuring the angle of the inner surface of the optical component in the high-speed optical transceiver module according to claim 1, wherein the multi-axis adjusting coupling frame comprises a bottom plate; a fixedly disposed vertical plate, a first plate connected to the vertical plate, and a second plate displaceable along an X-axis direction are disposed on the bottom plate, the laser output head displaceable along a Z-axis direction and a Y-axis direction is disposed on the first plate, a spiral jacking rod for enabling the first plate to rotate around a Z-axis is disposed on the vertical plate, and the telecentric objective is disposed on the second plate.

3. The apparatus for measuring the angle of the inner surface of the optical component in the high-speed optical transceiver module according to claim 1, wherein the multi-dimensional adjusting frame comprises an X-axis linear stage module and/or a Y-axis linear stage module and/or a Z-axis linear stage module and/or an X-axis rotation module and/or a Y-axis rotation module and/or a Z-axis rotation module.

4. The apparatus for measuring the angle of the inner surface of the optical component in the high-speed optical transceiver module according to claim 1, wherein the metal part fixing fixture comprises a base plate configured to connect to the multi-dimensional adjusting frame and a cover plate connected to the base plate, and the base plate and the cover plate are each provided with a corresponding optical fiber semicircular limiting groove and a corresponding metal part limiting groove.

5. The apparatus for measuring the angle of the inner surface of the optical component in the high-speed optical transceiver module according to claim 4, wherein the base plate and the cover plate are each detachably connected to a positioning block, and the metal part limiting groove is disposed on the positioning block.

6. The apparatus for measuring the angle of the inner surface of the optical component in the high-speed optical transceiver module according to claim 4, wherein the base plate and the cover plate each comprise a magnet disposed at a corresponding position corresponding to the other.

7. The apparatus for measuring the angle of the inner surface of the optical component in the high-speed optical transceiver module according to claim 1, wherein the base of the light-receiving positioning plate comprises a plurality of positioning pin shafts, and the light-receiving positioning plate is provided with positioning holes mating with the plurality of positioning pin shafts.

8. The apparatus for measuring the angle of the inner surface of the optical component in the high-speed optical transceiver module according to claim 1, wherein the visual recognition unit comprises a CCD and a display, an annular light source is disposed on a lens of the CCD, and the display is connected to the CCD.

9. A method for measuring an angle of an inner surface of an optical component in a high-speed optical transceiver module using the apparatus according to claim 1, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

10. The method for measuring the angle of the inner surface of the optical component in the high-speed optical transceiver module using the apparatus according to claim 2, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

11. The method for measuring the angle of the inner surface of the optical component in the high-speed optical transceiver module using the apparatus according to claim 3, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

12. The method for measuring the angle of the inner surface of the optical component in the high-speed optical transceiver module using the apparatus according to claim 4, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

13. The method for measuring the angle of the inner surface of the optical component in the high-speed optical transceiver module using the apparatus according to claim 5, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

14. The method for measuring the angle of the inner surface of the optical component in the high-speed optical transceiver module using the apparatus according to claim 6, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

15. The method for measuring the angle of the inner surface of the optical component in the high-speed optical transceiver module using the apparatus according to claim 7, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.

16. The method for measuring the angle of the inner surface of the optical component in the high-speed optical transceiver module using the apparatus according to claim 8, comprising:
placing a 0° plane standard means in the metal part fixing fixture, and adjusting the multi-axis adjusting unit so that a reflected light returns to a center of the light-receiving positioning plate;
moving the 0° plane standard means outward by a preset distance along the multi-axis adjusting unit, and adjusting so that the reflected light returns along an original path, to ensure that the far-near field movement axis of the multi-axis adjusting unit is perpendicular to a plane of the light-receiving positioning plate;
rotating the 0° plane standard means by 360° and adjusting the multi-axis adjusting unit to keep a reflected light spot at the center of the light-receiving positioning plate, to ensure that a rotation axis of the multi-axis adjusting unit is perpendicular to the plane of the light-receiving positioning plate;
placing an optical component to be measured in the calibrated metal part fixing fixture;
setting a distance L between an inner surface of the optical component to be measured and the light-receiving positioning plate;
using a CCD of the apparatus to acquire position information of the reflected light spot on the light-receiving positioning plate;
measuring a distance r between the reflected light spot and the center of the light-receiving positioning plate;
calculating an angle θ₁ of the inner surface of the optical component based on Δr, a variation of the distance between the reflected light spot and the center of the light-receiving positioning plate when the far-near field of the multi-dimensional adjusting frame is adjusted to move ΔL;
$${θ}_{1} = \frac{1}{2} {tan}^{- 1} ( \frac{Δ r}{Δ L} )$$
acquiring an azimuth angle of the reflected light spot on the light-receiving positioning plate through the CCD;
determining a high-side position and a low-side position of the inner surface of the optical component based on the azimuth angle of the reflected light spot; and
displaying the calculated angle value and position information of a high side and a low side on the display.
